(19) United States
(12) Patent Application Publication
(10) Pub. No.: US 2021/0279406 A1
(43) Pub. Date: Sep. 9, 2021

(54) TELEPROMPTER-STYLE PRESENTATION OF CLOSED-CAPTION TEXT

(71) Applicant: KUB Technologies Inc., Stratford, CT (US)

(72) Inventors: Fountain Jones, Cortladt Manaor, NY (US); Peter Yasutake, Stratford, CT (US); Kermit Eugene Graf, Austin, TX (US); Vikram Butani, Stratford, CT (US)

(73) Assignee: KUB Technologies Inc., Stratford, CT (US)

(21) Appl. No.: 17/172,491

(22) Filed: Feb. 10, 2021

Related U.S. Application Data
(60) Provisional application No. 62/972,401, filed on Feb. 10, 2020.

(51) Int. Cl. G06F 40/149; G10L 15/26; G10L 25/78; G06F 3/0484; H04N 5/222

(52) U.S. Cl. CPC G06F 40/149; G10L 15/26; G10L 2025/783; G06F 3/0484; H04N 5/2222; G10L 25/78

(57) ABSTRACT

An apparatus takes text from a speech recognition device and converts this text into a smooth rolling presentation of text. The aspects of the disclosed embodiments are suited for use in a closed caption presentation of text. The user sees a smooth rolling presentation of text. Generally, a full screen of text, or 9-10 lines of text, can be presented in a smooth, rolling manner, without interruptions or pauses. There are no bursts of text, that might otherwise be realized with conventional devices. The rate of delivery of the text can be adjusted to match the rate of the speaker.

### FIELD

The aspects of the disclosed embodiments relate generally to the field of closed captioning and in particular to an apparatus for delivering closed captioning text in a smooth rolling manner.

### BACKGROUND

A teleprompter is a display device that is generally understood to prompt the person speaking with electronically presented visual text of a speech or script. The text to be spoken is presented on a screen that the speaker can see. The teleprompter creates the illusion that the speaker has memorized the speech or is speaking spontaneously while looking directly at the audience.

Closed-Captioning is the practice of transcribing voice into text for the deaf and hard of hearing. It is traditionally a service provided by a highly-skilled closed-captionist or court reporter using a stenograph machine. Applying teleprompter art to Closed-Captioning services gives a more readable presentation of that service, especially when the captioning service is a speech-recognition based service.

With the advent of computer-based speech-recognition systems becoming ever-more accurate and commonly available, a less-skilled “voice-captionist” is able to provide the same services of equal or better quality, especially for fast-speaking events. A voice-captionist simply re-speaks the event. Punctuation is added by speaking: “period.” “comma.” “new paragraph.” etc. A captioning service is either offline (adding text to a pre-recorded event for later playback) or real-time.

Voice-captioning requires words and sentences to be quickly and reliably converted from speech into text. Sophisticated software algorithms are used to analyze words in the context of other words to achieve accurate results. These algorithms often impose a computational delay, leading to bursts of text sent to the display which can interrupt readability of the text. There is a need to “smooth out” these bursts (as if they never occurred) into a smoothly-scrolling presentation.

These algorithms can be demonstrated on a smart phone as follows: Activate its speech-to-text feature. Speak: “A family has two children.” The word “to” is initially written, then quickly changed to its homonym “two.” Algorithms analyze words in context of other words before reaching a solution. A real-time (human) captionist using a steno machine instantly knows which homonym to use. In the case of voice-captioning, human decisions are replaced by a computer which uses artificial intelligence algorithms to replicate human knowledge. Applied in a real-time environment, they can lead to computational delays and, therefore, a need for an improved presentation of closed-captioned style text at a speaking type of event.

At an event where speaking is very fast and the voice captionist needs to maintain the same pace as the speaker, along with speaking the needed punctuation, there is often no time for pausing between sentences and paragraphs. Algorithms tend to build up streams of text before flushing those streams to the output display. The above example is a simple, self-paced speaking example. Realtime, non-self-paced, events are more challenging for algorithms.

During a speaking event, Closed-Caption text is displayed on a large computer monitor located in front of the target audience. Text fills the monitor as multiple lines of Closed-Caption text are delivered. Communication Access Real-Time Translation (CART) is the industry name for this type of presentation. It is becoming common-place for voice-captionists to deliver CART-style Closed-Captioning, in lieu of a highly-skilled Realtime Captionist using a steno machine. A less-skilled person re-speaks the event into a computer microphone, adding punctuation and formatting in real-time, as needed. Software algorithms analyze the speech and convert it to text. This process sometimes results in bursts of text being sent to the display, as it is up to computer algorithms to determine when analysis is complete on a sequence of utterances. Thus, with the advent of computer speech-recognition systems used for Closed-Captioning, and the algorithms involved, there becomes the need to recharacterize the output into a smoothly-scrolling presentation, thereby aiding readability and comprehension of the spoken word.

Accordingly, it would be desirable to provide a captioning and text presentation apparatus that addresses at least some of the problems identified above.

### BRIEF DESCRIPTION OF THE DISCLOSED EMBODIMENTS

As described herein, the exemplary embodiments overcome one or more of the above or other disadvantages known in the art. These and other advantages are addressed by the subject matter of the independent claim. Further advantageous modifications can be found in the dependent claims.

One aspect of the exemplary embodiments relates to a device for taking text from a speech recognition device and converting this text into a smooth rolling presentation of text. The aspects of the disclosed embodiments are suited for use in a closed caption presentation of text. The user sees a smooth rolling presentation of text. Generally, a full screen of text, or 9-10 lines of text, can be presented in a smooth, rolling manner, without interruptions or pauses. There are no bursts of text, that might otherwise be realized with conventional devices. The rate of delivery of the text can be adjusted to match the rate of the speaker.

According to a first aspect, the above and further advantages of the disclosed embodiments are obtained by an apparatus. In one aspect, the apparatus includes a processor configured to execute non-transistory machine readable instructions; a memory configured to store the non-transitory machine readable instructions; and a text output device. Execution of the non-transistory machine readable instructions by the processor causes the processor to receive an input of text at a first rate; store the input of text in the memory; detect a text output rate control signal: and output a stream of text to the text output device at a second rate corresponding to the text output rate control signal, the output stream of text corresponding to the input text and the second rate being different from the first rate.

In a possible implementation form the apparatus further includes a speech recognition device, the speech recognition device configured to detect a speech input signal and convert the speech input signal to the input of text.

In a possible implementation form of the apparatus the text output device is one or more of a display device or an audio output device.

In a possible implementation form of the apparatus the processor is further configured to detect a text style output control signal, the text style output control signal configured to cause the processor to control the output of the stream of text to the text output device by one of outputting the stream of text one letter at a time at the second rate; outputting the stream of text one word at a time at the second rate; or outputting the stream of text one line of text at a time at the second rate.

In a possible implementation form of the apparatus, the processor is further configured to detect a text style output control signal, the text style output control signal configured to cause the processor to control the output of the stream of text to the text output device by one of aggregating the input text and outputting an entire line of text as the output stream of text; aggregating all characters of a single word of the input text and outputting the single word as the output stream of text; or outputting a constant stream of text characters from the input text as the output stream of text.

In a possible implementation form of the apparatus, the input text corresponds to spoken speech, and the processor is further configured to detect a rate of speech output of the spoken speech; set a rate of the output of the stream of text to the text output device to correspond to the detected rate of the spoken speech; and output the stream of text to the text output device at the set rate.

In a possible implementation form of the apparatus, the text output device comprises a graphical user interface, the graphical user interface including a first window for displaying the input text and a second window for displaying the output stream of text.

In a possible implementation form of the apparatus, the processor is configured to cause the second window of the graphical user interface to display the output stream of text as a smooth rolling presentation of text.

In a possible implementation form of the apparatus, the graphical user interface further comprises a tool bar, the tool bar configured to provide controls for configuring the output stream of text, the controls including a speed control device configured to provide the second rate at which the text output is presented in the second window; a streaming style control device configured to enable the processor to present the stream of text in the second window one letter at a time at the second rate; one word at a time at the second rate; or one line of text at a time at the second rate. A clear text control is configured to enable the processor to clear text from one or more of the first window and second window; and a flush text control is configured to enable the processor to cause any text remaining in the memory to be outputted for display in the second window. The processor is further configured to detect an input from one or more of the controls and adjust the output of the stream of text to the second window of the graphical user interface based on the detected input.

In a possible implementation form of the apparatus, the first rate is a burst of text and the second rate is configured to control a rate of delivery of the output stream of text to the second window to enable a smooth presentation of text in a display window of the text output device.

According to a second aspect, the above and further advantages are obtained by an apparatus for controlling an output of text received from a speech-to-text device. In one embodiment, the apparatus includes a processor configured to execute non-transistory machine readable instructions; a memory configured to store text received from the speech-to-text device; a text output device; and a control device configured to control an output of text stored in the memory to the text output device. Execution of the non-transistory machine readable instructions by the processor causes the processor to detect a rate control signal from the control device, the rate control signal configured to control a rate at which text from the memory is output to the text output device; detect a stream control signal from the control device, the stream control signal configured to enable the processor to provide the text from the memory to the text output device one letter of the text at a time at the rate corresponding to the rate control signal; one word of the text at a time at the rate corresponding to the rate control signal; or one line of the text at a time at the rate corresponding to the rate control signal. The output of the text to the text output device is adjusted and controlled based on the detected rate control signal and the detected stream control signal.

In a possible implementation form of the apparatus, the output device comprises a graphical user interface and the processor is configured to enable the graphical user interface to display the output of text in a window of the graphical user interface.

In a possible implementation form the apparatus, the processor is further configured to detect a text style output control signal from the control device and control the output of the text by one of aggregating the text stored in the memory and sending an entire line of text as the output of text; aggregating all characters of a single word of the input text and outputting the single word as the output of text; or outputting a constant stream of text characters from the input text as the output of text.

In a possible implementation form of the apparatus, the text output device is one or more of an audio output device or a display device.

In a possible implementation form of the apparatus, the processor is further configured to detect a rate of spoken speech corresponding to the text received from the speech-to-text device; set a rate of the rate control signal to correspond to the detected rate; and output the text to the text output device at the set rate.

In a possible implementation form of the apparatus, the processor is further configured to detect a clear text control signal from the control device, the clear text control signal configured to enable the processor to clear text presented on a display of the text output device; and detect a flush text control signal, the flush text control signal configured to enable the processor to cause text remaining in the memory to be outputted to the text output device.

According to a third aspect, the above and further advantages are obtained by a method. In one embodiment, the method includes a processor executing non-transitory machine-readable instructions, the execution of the non-transitory machine-readable instructions configured to cause the processor to receive an input of text at a first rate from a speech-to-text device; store the input of text in a memory device; detect a text output rate control signal: and output a stream of text to a text output device at a second rate corresponding to the text output rate control signal. The output stream of text corresponds to the input text and the second rate is different from the first rate.

In a possible implementation form of the method, execution of the non-transitory machine readable instructions by the processor is further configured to cause the processor to detect a rate control signal from a control device and control a rate at which text from the memory is output to the text output device.

In a possible implementation form of the method, execution of the non-transitory machine readable instructions by the processor is further configured to cause the processor to output the stream of text one letter at a time at the rate corresponding to the rate control signal; output the stream of text one word at a time at the rate corresponding to the rate control signal; or output the stream of text one line of text at a time at the rate corresponding to the rate control signal.

The aspects of the disclosed embodiments allow the audience of a speaking event, such as deaf and/or hard of hearing, to more easily read and understand a speech as the words are being spoken. In simple terms, the aspects of the disclosed embodiments produce a teleprompter-style presentation of Closed-Caption text, but with the text being presented in a controllable, smooth rolling format, without any bursts of text.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the present disclosure, and together with the general description given above and the detailed description given below, serve to explain the principles of the present disclosure. As shown throughout the drawings, like reference numerals designate like or corresponding parts.

FIG. 1 illustrates a block diagram of an exemplary system incorporating aspects of the disclosed embodiments.

FIG. 2 illustrates an exemplary input window of a device incorporating aspects of the disclosed embodiments.

FIG. 3 illustrates an exemplary output window of a device incorporating aspects of the disclosed embodiments.

FIG. 4 is a flow chart illustrating a process flow incorporating aspects of the disclosed embodiments.

FIG. 5 is a block diagram of an exemplary apparatus that can be used to implement aspects of the disclosed embodiments.

### DETAILED DESCRIPTION OF THE EXEMPLARY EMBODIMENTS OF THE DISCLOSURE

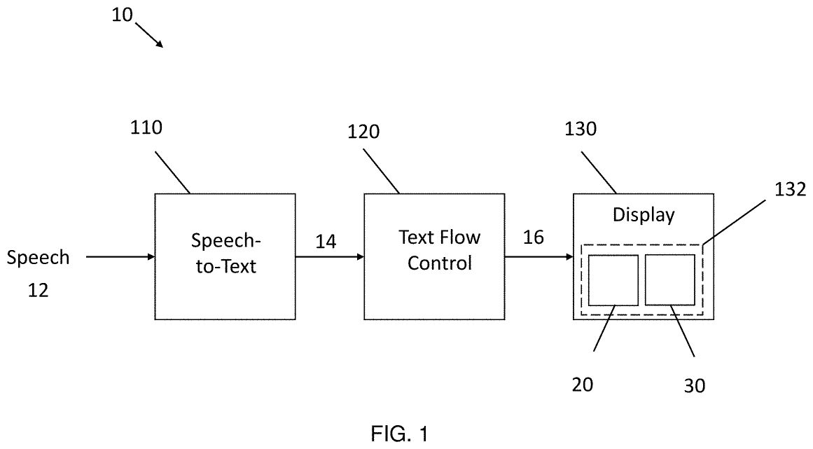

Referring to FIG. 1, one embodiment of a system or apparatus 10 incorporating aspects of the disclosed embodiments is illustrated. The aspects of the disclosed embodiments are directed to a system 10 that is configured to receive as an input, text from a speech-to-text or speech recognition device 110 and output a smooth rolling presentation of text on an output device or apparatus 130. Commonly, these text inputs are received as bursts of text. The aspects of the disclosed embodiments are configured to control and smooth the bursts that might otherwise be presented in typical speech-to-text conversion.

As shown in FIG. 1, the speech recognition device 110 is configured to receive as an input 12 a stream of spoken speech or other user generated utterances that can be converted into text. As an example, the speech recognition device 110 can comprise a computing device executing a speech-to-text algorithm. As a person talks, the spoken words are converted by the speech recognition device 110 into text, which can be presented on a display, such as the output device 130.

One example of a speech-to-text algorithm or device is DRAGON™. As a user speaks, the spoken words are converted into text and presented on a display or other suitable program, such as a WORD™ document or an electronic mail message. Although a speech-to-text algorithm device is generally referred to herein, the aspects of the disclosed embodiments are not so limited. In alternate embodiments, the source of the data text stream 14 to the text flow control device 120 can be any suitable source.

In accordance with the aspects of the disclosed embodiments, the data output 14 of the speech recognition device 110, which in one embodiment is a text data stream, is input or otherwise delivered to the text flow control device 120. The text flow control device 120 is configured to receive the text from the speech recognition device 110 in real-time at some irregular rate, temporarily preserve the text in a memory buffer, and then output that same text at a regular, controlled, rate without changing the order of the text. Generally, the processing of the text by the text flow control device 120 is in a first-in, first-out (FIFO) sequence.

In one embodiment, the text flow control device 120 is configured to receive as an input, the text output 14, store and/or reconfigure the inputted text data. For example, in one embodiment, the text flow control 120 is configured to receive the text 14 and save or buffer this received text. The text flow control device 120 is then configured to output or “push” out the reconfigured or reformatted text data 16 at a predetermined rate, also referred to herein as “speed.” The aspects of the disclosed embodiments are configured to regulate the delivery rate or speed of the reconfigured text. In this manner, the output or delivery of the text is controlled, and the user sees a smooth rolling presentation of text on the output device 130.

The text flow control device 120 can be likened to a sand hourglass, where the top, or hopper, of the hourglass is open, receiving sand (i.e., text) at some irregular rate. Sand is discharged through the orifice at the bottom of the hopper at a constant flow rate. If one were to increase the diameter of the orifice, sand would discharge at a faster rate. By increasing or decreasing the diameter of the orifice, the sand can be discharged at a faster or slower rate. Applying this simple analogy to the text flow-control apparatus or device 120 of the disclosed embodiments, the discharge rate is controllable via a speed setting of output text, a control which is further described herein. If the hopper empties of sand too quickly (e.g. text), the orifice (e.g. speed control) can be reduced to maintain an even flow. The speed control is adjusted according to the gradual buildup or depletion of text coming into the text flow control device 120 until such time an equilibrium is reached.

Carrying this analogy a bit further, there is consideration that the hourglass (i.e. the text flow control device 120 of the disclosed embodiments) is operational in real-time for a long period of time. Sand passing through the orifice would build up in the lower hourglass hopper. To prevent an undue build-up approaching the limits of the lower hourglass hopper, a discarding process is used where sand is removed. Applying this concept to the aspects of the disclosed embodiments, in the text flow control device 120, text is removed. A FIFO rule is used to decide which text to remove. i.e., an always-oldest-text rule. This is construed as a “trimming” action, removing text from the device memory. Trimming is a control described later as either a manual action (single action) or automatic action where the text flow control device 120 internally decides the text to discard as a repeated, real-time action.

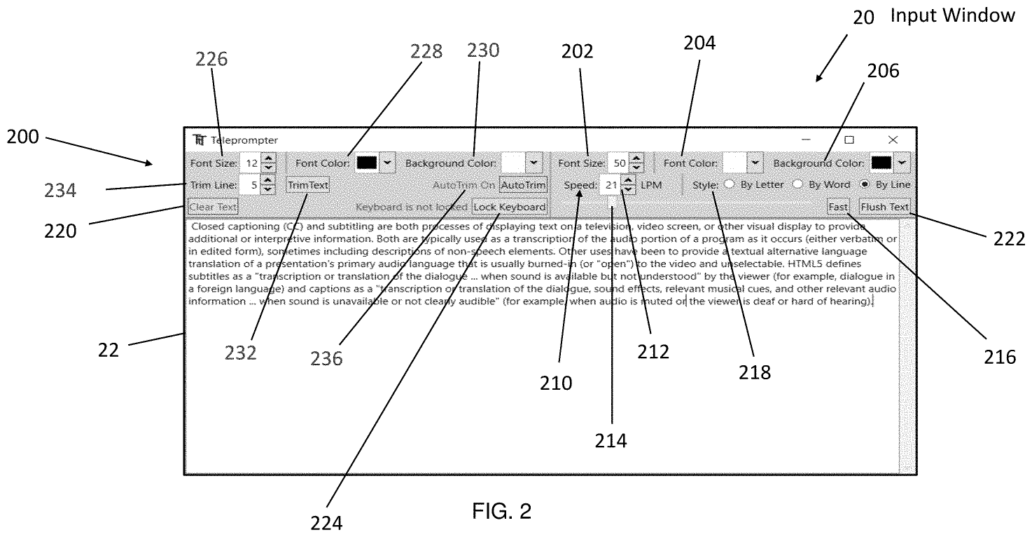

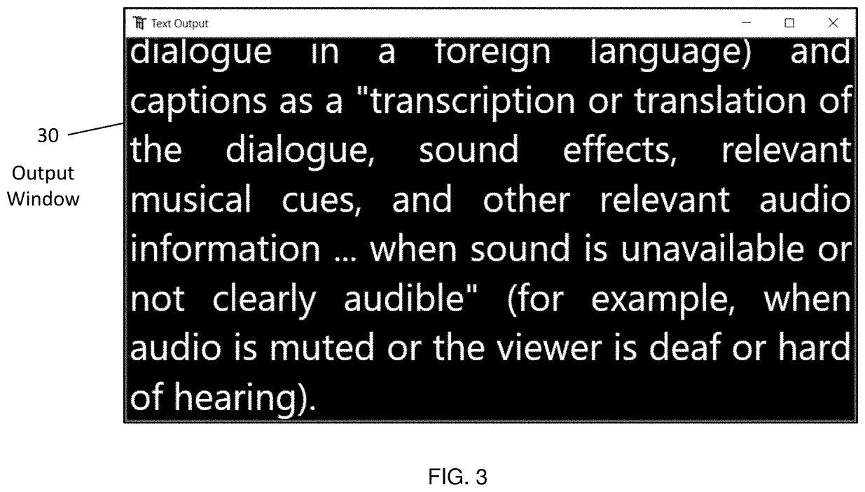

Referring also to FIGS. 2 and 3, in one embodiment, the output device 130 of the system 10 generally comprises a display unit that includes a graphical user interface 132. As shown in FIG. 1, the graphical user interface 132 can include an Input Window 20 and an Output Window 30. Although the output or display device 130 of the system 10 is shown as a separate device, the aspects of the disclosed embodiments are not so limited. In one embodiment, the output device 130 can be part of or included with the text flow control device 120. For example, in one embodiment, the output device 130 can comprise one or more display units of the device 120. In one embodiment, the display unit 130 can also include or comprise an audio output device. The text output from the text flow control device 120 could be converted in real-time to audio. This audio could then be delivered to the user via for example, a headset or earbud style audio output device. This could be advantageous to enable a closer correspondence between the text output and the audio output.

Further, although the input window 20 and output window 30 are shown as separate windows, in one embodiment the input window 20 and the output window 30 can comprise the same window of the graphical user interface 132. Alternatively, the input window 20 and output window 30 can comprise separate portions of the graphical user interface. The aspects of the disclosed embodiments are not intended to be limited by what portion of the display the outputted text 16 is presented.

The input window 20 is configured to present or display the text 14 being sent from the speech recognition device 110. The Output Window 30 presents the text 16 from the text flow control device 120. In one embodiment, the text 16 from the device 120 is presented on the output window as Closed-Captioning text to recipients (deaf and hard of hearing).

FIG. 2 illustrates an exemplary input window 20 of the output device 130 incorporating aspects of the disclosed embodiments. In this example, the input window 20, which can be part of the graphical user interface 132, also referred to as GUI 132, includes a text display portion 22 and control or tool bar portion 200. The text portion 22 is configured to present the text 14 in a form as it is delivered from the speech recognition device 110.

Carrying the hourglass analogy a bit further, there is a consideration to indicate dynamically (in real-time) which character or word from the input window 20 is being sent to and displayed in the output window 30. i.e., which grain of sand is currently passing through the orifice. A visual que in the form of a dynamically moving cursor or symbol in the input Window 20 identifies in real-time the character or word currently being passed to the output window 30. In one embodiment this visual que is a red vertical line character dynamically moving within the input window 20. As the output window 30 receives text, or has new text scroll into view, the red line will reposition itself within the input text window. This shows the exact point at which the output window 30 is displaying text from the input window 20.

As shown in FIG. 2, the control or tool bar 200 includes one or more control devices that can be used to implement aspects of the disclosed embodiments. In one embodiment, the control bar 200 can include one or more static controls that are used to control the appearance and readability of text in the output window 30 shown in FIG. 3 and the input window 20 of FIG. 2. Examples of the static controls can include, but are not limited to, background color control devices 206 and 230, font color control devices 204 and 228, and font size control devices 202 and 226.

The background color control device 206 is configured to be used to control a color of the background of the output window 30. In the example of FIG. 3, the background color is black.

The font color control device 204 is configured to be used to control the color of the text displayed in the output window 30. In the example of FIG. 3, the color is white.

The font size control device 202 is configured to be used to control a size of the text displayed in the output window 30. Other static control devices can include but are not limited to a font style, contrast and brightness of the output window 30.

The background color control device 230 is configured to be used to control a color of the background of the input window 20. In the example of FIG. 2, the background color is white.

The font color control device 228 is configured to be used to control the color of the text displayed in the input window 20. In the example of FIG. 2, the color is black.

The font size control device 226 is configured to be used to control a size of the text displayed in the input window 20.

The control bar 200 can also include one or more dynamic control devices. The dynamic controls are used to control the streaming of text to the output window 30. In one embodiment, the control bar 200 includes a speed control device 210, also referred to as a rate or scrolling speed. The speed control 210 can be used to control a rate at which the text is presented and displayed in the output window 30. In one embodiment, the speed control 210 can be used to set the rate of the text output on the window 30 to approximately match the talking speed of the event. For example, a singing event may require an appreciably faster speed than a discourse or lecture event.

In one embodiment, the apparatus 10 can be configured to automatically detect the talking speed or rate. The detected rate can then be used as the rate for the text output.

In one embodiment, the speed control device 210 can include a numeric control. In the example of FIG. 2, the numeric control includes incremental values ranging from 1-100, that can be selected or adjusted by the user. In alternate embodiments, the speed control device 210 can be configured with any suitable control that can be used to match the text output to the approximate speed at which the speaker is talking. The increments can be any suitable or desired increments.

For example, in one embodiment, the speed control device 210 comprises a slide or slider-bar control device 214. The slider-bar control device 214 can be configured to be adjusted to a fast rate, such as for example to have the text presented in the output window 30 catch-up to the speaker, and then adjusted to another position to slow-down the output rate to a regular or other speed setting.

In one embodiment, the speed control device 210 can include a “fast” control device 216. The fast control device 216 is presented in FIG. 2 as a selectable button that can be activated in a manner as is generally understood. As an example, the user can click and hold the fast control device 216 to momentarily increase the rate at which the text is delivered to the output window 30 to “catch up.” Releasing the fast control device 216 is configured to revert the speed back to a predetermined setting, such as the original rate prior to activation of the fast control button 216.

The control bar 200 can also include a streaming style control 218. The streaming style control 218 is configured to control the granularity of streaming text to the output window 30. This can include selections or settings for a “by letter” control, which enables a streaming of text to the output window 30 one letter at a time, a “by word” control, which enables a streaming of one word at a time to the output window 30, and a “by line” control, which enables a streaming of one line of text at a time to the output window 30.

In one embodiment, the control bar 200 can also include a Clear Text 220, which is configured to clear the text from both input window 20 and the output window 30. The control bar 200 can also include a flush text control 222. The flush text control 222 is configured to flush or cause any remaining text to be presented on the Output Window 30.

In one embodiment, referring also to FIG. 2, the control bar 200 includes a speed or rate control device 212. The speed control 212, as will be further described herein, is configured to enable the user to adjust the rate at which the text is output from the device 120 and presented in the output window 30. The aspects of the disclosed embodiments are directed to eliminating the “burst” type of text output that is typically encountered with text-to-speech conversion devices and present the spoken text in a smooth manner on the output window 30, the rate of which can also be controlled by the user.

In one embodiment, the range of control of the speech rate output, in the form of the textual display, can include a slow output rate to a fast output rate. In one embodiment, the system 10 is configured to determine a rate of speech output of the speaker and set the rate of the text output to correspond to the speech rate of the speaker.

In one embodiment, the control bar 200 includes a Lock Streaming Source control device 224. The lock streaming source control device 224 is configured to lock the connection between the device 120 and the speech-recognition application of the speech recognition device 110. This prevents that connection from being disturbed by other user interactions with the computer, such as mouse or keyboard activity.

In one embodiment, the control bar 200 includes a Trim Text control device 232. The trim text control device 232 is configured to prevent unnecessary retention of text in memory, by discarding it from memory. Text is removed using a FIFO rule (first-in, first out/removed). This is text that has been displayed in both input window 20 and output window 30 and is of no further use, such as in a real-time event, and can be discarded. Importantly, text is discarded in a way that does not interrupt, or affect in any way, the smooth-scrolling of newer text currently visible and being presented on output window 30. Using the FIFO rule, oldest text is removed first. The Trim Line control device 234 controls how many lines of text need to be retained. Any lines of text beyond this limit are discarded. In one embodiment, trim text is a manual, single block of text, trimming action.

During a real-time event, a repeated trimming is optimal, and this is done using the AutoTrim on/off control device 236. Setting this control to On activates an automatic and repeated trimming of text, each time using the trim line control device 234 setting.

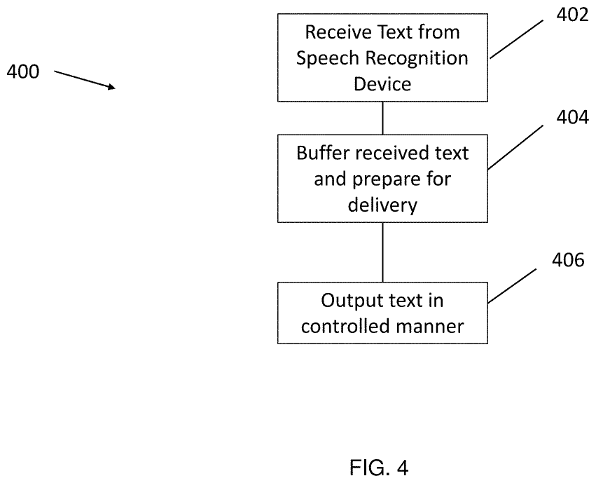

FIG. 4 is a flowchart of an exemplary process 400 incorporating aspects of the disclosed embodiments. In one embodiment, text is received 402 from a speech recognition device. The received text is buffered or otherwise stored, and prepared 404 for delivery to the output window. Text is then output 406 in a controlled manner.

In one embodiment, a final preparation of text for output 406 is to apply Style setting 218 which controls the granularity of the output text stream. If style is set to “By Line”, an entire line of text is first aggregated, and then output 406. If style is set to “By Word”, all characters of a word are first aggregated, and then output 406. If style is set to “By Letter”, the text is outputted 406 as a constant stream of characters. The speed of this streaming process is set by the various speed control settings.

Text attributes of size and color are embodied in the output stream. Events that alter the flow of streaming text can include: 1) all text has been processed and streaming pauses, 2) a clear text event clears all text previously sent for output 406, 3) a flush text abruptly flushes all remaining text for output 406. The text is then outputted 406 to the output window. The aspects of the disclosed embodiments are configured to output a smooth rolling presentation of text on the output window.

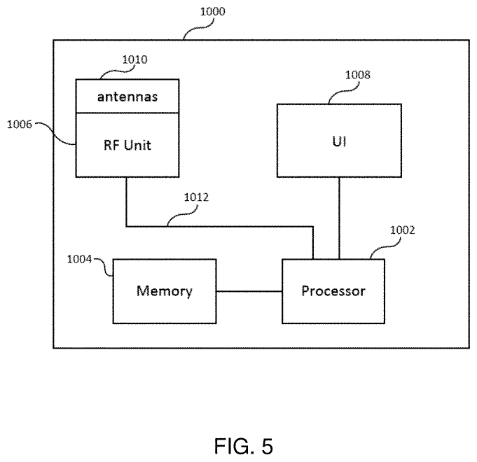

FIG. 5 illustrates a block diagram of an exemplary apparatus 1000 appropriate for implementing aspects of the disclosed embodiments. The apparatus 1000 is appropriate for use in a wireless network and can be implemented in one or more of a transmitting apparatus or a receiving apparatus. The apparatus 1000 can be implemented in a network and can include various types of computing and mobile computing devices, including various types of wireless communications user equipment such as cell phones, smart phones and tablet devices.

The apparatus 1000 includes or is coupled to a processor or computing hardware 1002, a memory 1004, a radio frequency (RF) unit 1006 and a user interface (UI) 1008. In one embodiment, the user interface 1008 comprises the graphical user interface 130 described herein. In certain embodiments the apparatus 1000 does not include a UI 1008.

The processor 1002 may be a single processing device or may comprise a plurality of processing devices including special purpose devices, such as for example, digital signal processing (DSP) devices, microprocessors, graphics processing units (GPU), specialized processing devices, or general purpose computer processing unit (CPU). The processor 1002 often includes a CPU working in tandem with a DSP to handle signal processing tasks. The processor 1002 may be configured to implement any of the methods described herein.

In the example of FIG. 4, the processor 1002 is configured to be coupled to a memory 1004 which may be a combination of various types of volatile and non-volatile computer memory such as for example read only memory (ROM), random access memory (RAM), magnetic or optical disk, or other types of computer memory. The memory 1004 is configured to store computer program instructions that may be accessed and executed by the processor 1002 to cause the processor 1002 to perform a variety of desirable computer implemented processes or methods such as the methods as described herein.

The program instructions stored in memory 1004 are organized as sets or groups of program instructions referred to in the industry with various terms such as programs, software components, software modules, units, etc. Each module may include a set of functionality designed to support a certain purpose. For example a software module may be of a recognized type such as a virtual execution environment, an operating system, an application, a device driver, or other conventionally recognized type of software component. Also included in the memory 1004 are program data and data files which may be stored and processed by the processor 1002 while executing a set of computer program instructions.

The apparatus 1000 can also include an RF Unit 1006 coupled to the processor 1002 that is configured to transmit and receive RF signals based on digital data 1012 exchanged with the processor 1002 and may be configured to transmit and receive radio signals with other nodes in a wireless network. In one embodiment, where the system 10 makes use of wireless communications, to facilitate transmitting and receiving RF signals the RF unit 1006 includes an antenna unit 1010 which in certain embodiments may include a plurality of antenna elements. The multiple antennas 1010 may be configured to support transmitting and receiving signals.

The UI 1008 may include one or more user interface elements such as a touch screen, keypad, buttons, voice command processor, as well as other elements adapted for exchanging information with a user. The UI 1008 may also include a display unit configured to display a variety of information appropriate for a computing device or mobile user equipment and may be implemented using any appropriate display type such as for example organic light emitting diodes (OLED), liquid crystal display (LCD), as well as less complex elements such as LEDs or indicator lamps. The display unit of the UI 1008 can include the input window 20 and output window 30 described herein.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed is:

1. An apparatus comprising:
a processor configured to execute non-transistory machine readable instructions;
a memory configured to store the non-transitory machine readable instructions; and
a text output device, wherein execution of the non-transistory machine readable instructions by the processor causes the processor to:
receive an input of text at a first rate;
store the input of text in the memory;
detect a text output rate control signal: and
output a stream of text to the text output device at a second rate corresponding to the text output rate control signal, the output stream of text corresponding to the input text and the second rate being different from the first rate.

2. The apparatus according to claim 1, further comprising a speech recognition device, the speech recognition device configured to detect a speech input signal and convert the speech input signal to the input of text.

3. The apparatus according to claim 1, wherein the text output device is one or more of a display device or an audio output device.

4. The apparatus according to claim 1, wherein the processor is further configured to detect a text style output control signal, the text style output control signal configured to cause the processor to control the output of the stream of text to the text output device by one of:
outputting the stream of text one letter at a time at the second rate;
outputting the stream of text one word at a time at the second rate; or
outputting the stream of text one line of text at a time at the second rate.

5. The apparatus according to claim 1, wherein the processor is further configured to detect a text style output control signal, the text style output control signal configured to cause the processor to control the output of the stream of text to the text output device by one of:
aggregating the input text and outputting an entire line of text as the output stream of text;
aggregating all characters of a single word of the input text and outputting the single word as the output stream of text; or
outputting a constant stream of text characters from the input text as the output stream of text.

6. The apparatus according to claim 1, wherein the input text corresponds to spoken speech, and the processor is further configured to:
detect a rate of speech output of the spoken speech;
set a rate of the output of the stream of text to the text output device to correspond to the detected rate of the spoken speech; and
output the stream of text to the text output device at the set rate.

7. The apparatus according to claim 1, wherein the text output device comprises a graphical user interface, the graphical user interface including a first window for displaying the input text and a second window for displaying the output stream of text.

8. The apparatus according to claim 7, wherein the processor is configured to cause the second window of the graphical user interface to display the output stream of text as a smooth rolling presentation of text.

9. The apparatus according to claim 8, wherein the graphical user interface further comprises a tool bar, the tool bar configured to provide controls for configuring the output stream of text, the controls including:
a speed control device configured to provide the second rate at which the text output is presented in the second window;
a streaming style control device configured to enable the processor to present the stream of text in the second window:
one letter at a time at the second rate;
one word at a time at the second rate; or
one line of text at a time at the second rate;
a clear text control configured to enable the processor to clear text from one or more of the first window and second window; and
a flush text control configured to enable the processor to cause any text remaining in the memory to be outputted for display in the second window; and
wherein the processor is further configured to detect an input from one or more of the controls and adjust the output of the stream of text to the second window of the graphical user interface based on the detected input.

10. The apparatus according to claim 1, wherein the first rate is a burst of text and the second rate is configured to control a rate of delivery of the output stream of text to the second window to enable a smooth presentation of text in a display window of the text output device.

11. An apparatus for controlling an output of text received from a speech-to-text device comprising:
a processor configured to execute non-transistory machine readable instructions;
a memory configured to store text received from the speech-to-text device;
a text output device; and
a control device configured to control an output of text stored in the memory to the text output device;
wherein execution of the non-transistory machine readable instructions by the processor causes the processor to:
detect a rate control signal from the control device, the rate control signal configured to control a rate at which text from the memory is output to the text output device;
detect a stream control signal from the control device, the stream control signal configured to enable the processor to provide the text from the memory to the text output device:
one letter of the text at a time at the rate corresponding to the rate control signal;
one word of the text at a time at the rate corresponding to the rate control signal; or
one line of the text at a time at the rate corresponding to the rate control signal; and
adjust the output of the text to the text output device based on the detected rate control signal and the detected stream control signal.

12. The apparatus according to claim 11, wherein the output device comprises a graphical user interface and the processor is configured to enable the graphical user interface to display the output of text in a window of the graphical user interface.

13. The apparatus according to claim 12, wherein the processor is further configured to detect a text style output control signal from the control device and control the output of the text by one of:
aggregating the text stored in the memory and sending an entire line of text as the output of text;
aggregating all characters of a single word of the input text and outputting the single word as the output of text; or
outputting a constant stream of text characters from the input text as the output of text.

14. The apparatus according to claim 13, wherein the text output device is one or more of an audio output device or a display device.

15. The apparatus according to claim 13, wherein the processor is further configured to:
detect a rate of spoken speech corresponding to the text received from the speech-to-text device;
set a rate of the rate control signal to correspond to the detected rate; and
output the text to the text output device at the set rate.

16. The apparatus according to claim 11, wherein the processor is further configured to:
detect a clear text control signal from the control device, the clear text control signal configured to enable the processor to clear text presented on a display of the text output device; and
detect a flush text control signal, the flush text control signal configured to enable the processor to cause text remaining in the memory to be outputted to the text output device.

17. A method comprising a processor executing non-transitory machine-readable instructions, the execution of the non-transitory machine-readable instructions configured to cause the processor to:
receive an input of text at a first rate from a speech-to-text device;
store the input of text in a memory device;
detect a text output rate control signal: and
output a stream of text to a text output device at a second rate corresponding to the text output rate control signal, the output stream of text corresponding to the input text and the second rate being different from the first rate.

18. The method according to claim 17, wherein execution of the non-transitory machine readable instructions by the processor is further configured to cause the processor to detect a rate control signal from a control device, and control a rate at which text from the memory is output to the text output device

19. The method according to claim 18, wherein execution of the non-transitory machine readable instructions by the processor is further configured to cause the processor to:
output the stream of text one letter at a time at the rate corresponding to the rate control signal;
output the stream of text one word at a time at the rate corresponding to the rate control signal; or
output the stream of text one line of text at a time at the rate corresponding to the rate control signal.

20. The method according to claim 19, wherein execution of the non-transitory machine readable instructions by the processor is further configured to cause the processor to:
detect a rate of spoken speech that forms an input to the speech-to text device;
set a rate of the output of the stream of text to the text output device to correspond to the detected rate of the spoken speech; and
output the stream of text to the text output device at the set rate.
